(19) United States
(12) Patent Application Publication
(10) Pub. No.: US 2020/0189641 A1
(43) Pub. Date: Jun. 18, 2020

(54) SWITCH DEVICE

(71) Applicant: KABUSHIKI KAISHA TOKAI RIKA DENKI SEISAKUSHO, Aichi (JP)

(72) Inventors: Tatsushi KATSUYAMA, Aichi (JP); Takashi NAGAO, Aichi (JP); Tetsuya EGAWA, Aichi (JP); Takeyoshi MORI, Aichi (JP)

(21) Appl. No.: 16/644,136

(22) PCT Filed: Aug. 28, 2018
(86) PCT No.: PCT/JP2018/031793

§ 371 Date: Mar. 3, 2020

(30) Foreign Application Priority Data
Sep. 19, 2017 (JP) 2017-179096

(51) Int. Cl. B62D 1/06; B60R 11/02; H01H 9/16; B60R 16/02; G05G 1/02; G05G 5/03; H01H 13/02; H04S 1/00

(52) U.S. Cl. CPC B62D 1/06; B60R 11/02; H01H 9/16; H04S 1/007; G05G 1/02; G05G 5/03; H01H 13/02; B60R 16/02

(57) ABSTRACT

A switch device that is installed on a steering wheel of a vehicle. The switch device includes a switch part that is installed on the vehicle and includes an operation knob and an electromagnetic element for detecting an operation on the operation knob and causing a vibration of the operation knob, and a control unit that performs at least one of a first control and a second control, the first control controlling the electromagnetic element such that the operation knob vibrates in response to the operation, and the second control controlling the electromagnetic element such that the operation knob vibrates at an audible band. The switch device is positioned such that a directivity of a sound emitted from the operation knob is increased toward an ear of an occupant of the vehicle.

### CROSS-REFERENCES TO RELATED APPLICATIONS

The present application claims the priority of Japanese patent application No. 2017/179096 filed on Sep. 19, 2017, and the entire contents of Japanese patent application No. 2017/179096 are hereby incorporated by reference.

### TECHNICAL FIELD

The present invention relates to a switch device.

### BACKGROUND ART

An acoustic system is present which is mounted on a vehicle to inform the situation of the surroundings of the vehicle by a three-dimensional audio image. The acoustic system is provided with a speaker for emitting sound, and a control unit from which an output signal corresponding to the situation of the surroundings of the vehicle is output to the speaker (see, e.g., Patent Literature 1). The control unit has a means for deriving parameters associated with driving safety such as positions and relative speeds of plural running vehicles around own vehicle and inter-vehicle distances, a means for determining the imminent danger level for own vehicle by comparing the parameters to conditions which are preset for determining the imminent danger level, a signal conversion circuit means for converting a signal of the parameter into a virtual sound source generation signal according to the result of determining the imminent danger level, a means for converting the virtual sound source generation signal into a pulse-like amplified signal by using a signal amplifier circuit, and a signal processing circuit means which inputs the amplified signal to the speaker to produce pulse sound at a position of the virtual sound source.

### CITATION LIST

### Patent Literature

Patent Literature 1: JP 2002/133596 A

### SUMMARY OF INVENTION

### Technical Problem

The acoustic system disclosed in Patent Literature 1 causes a problem that it needs to be separately provided with the speaker to emit a sound in order to generate three-dimensional audio images inside the vehicle interior.

It is an object of the invention to provide a switch device which is installed on a steering wheel to generate the three-dimensional audio images.

### Solution to Problem

According to an embodiment of the invention, a switch device may be configured as defined by [1] to [10] below.

[1] To achieve the above-mentioned object, provided is a switch device that is installed on a steering wheel of a vehicle, the switch device comprising: a switch part that is installed on the vehicle and comprises an operation knob and an electromagnetic element for detecting an operation on the operation knob and causing a vibration of the operation knob; and a control unit that performs at least one of a first control and a second control, the first control controlling the electromagnetic element such that the operation knob vibrates in response to the operation, and the second control controlling the electromagnetic element such that the operation knob vibrates at an audible band, wherein the switch device is positioned such that a directivity of a sound emitted from the operation knob is increased toward an ear of an occupant of the vehicle.

[2] The switch device according to [1], wherein as the second control, the control unit drives the electromagnetic element so that a warning tone or warning sound is output from the operation knob.

[3] The switch device according to [2], wherein the control unit outputs a sine-wave drive signal with a frequency in the audible band to the electromagnetic element so that the warning tone is output from the operation knob.

[4] The switch device according to [2], wherein the control unit outputs a drive signal based on a sound signal in the audible band, to the electromagnetic element so that the warning sound is output from the operation knob.

[5] The switch device according to any one of [1] to [4], wherein the electromagnetic element comprises a piezoelectric element.

[6] The switch device according to any one of [1] to [5], wherein the number of the switch parts provided on the steering wheel is at least two, and wherein the control unit performs, as a part of the second control, control of properties of sound output from each switch part so that a three-dimensional audio image produced by sounds output from the switch parts is maintained.

[7] The switch device according to [6], wherein the at least two switch parts are arranged across a center line passing through the center of a seat or the steering wheel in the vehicle.

[8] The switch device according to [6] or [7], wherein one of the at least two switch parts which is located on a right side with respect to the center line is positioned to increase the directivity toward a right ear of the occupant, and wherein one of the at least two switch parts which is located on a left side with respect to the center line is positioned to increase the directivity toward a left ear of the occupant.

[9] The switch device according to any one of [6] to [8], wherein the control unit comprises phase shift means and adding means, wherein the phase shift means performs a phase-delay process to the sound signal of a right channel corresponding to the one of the at least two switch parts located on the right side with respect to the center line and to the sound signal of a left channel corresponding to the one of the least two switch parts located on the left side with respect to the center line, and wherein the adding means outputs a drive signal of the right and left channels respectively by adding the sound signal of the right channel to the sound signal of the left channel phase-delayed by the phase shift means and the sound signal of the left channel to the sound signal of the right channel phase-delayed by the phase shift means.

[10] The switch device according to [9], wherein the control unit sets respective phase differences in the phase shift means so that, at the right ear of the occupant, a synthetic sound of sound based on the sound signal of the right channel and sound based on the sound signal of the right channel phase-delayed by the phase shift means is maximized and a synthetic sound of sound based on the sound signal of the left channel and sound based on the sound signal of the left channel phase-delayed by the phase shift means is minimized, and at the left ear of the occupant, a synthetic sound of sound based on the sound signal of the left channel and sound based on the sound signal of the left channel phase-delayed by the phase shift means is maximized and a synthetic sound of sound based on the sound signal of the right channel and sound based on the sound signal of the right channel phase-delayed by the phase shift means is minimized.

### Advantageous Effects of invention

According to an embodiment of the invention, it is possible to provide a switch device which is installed on a steering wheel to generate the three-dimensional audio images.

### BRIEF DESCRIPTION OF DRAWINGS

FIG. 1 is a front view showing a switch device in an embodiment in the case of being mounted on a steering wheel of a vehicle when viewing the steering wheel from a driver.

FIG. 2 is a cross sectional view showing the switch device taken along a line A-A in FIG. 1.

FIG. 3 is a top view showing an arrangement example of the switch device when viewing the vehicle from above, in the case that the switch device in the embodiment is mounted on the steering wheel of the vehicle.

FIG. 4 is a side view when the switch device is viewed in the direction C in FIG. 3.

FIG. 5 is a schematic block diagram illustrating a configuration of the switch device in the embodiment.

FIG. 6 shows an waveform example of a drive signal of a right channel for driving an operation knob, wherein a drive signal Sh1 is to provide tactile sensation by causing vibration of the operation knob in response to a touch operation, a drive signal Ss1 is to produce a beep from the operation knob, and a drive signal Ss1′ is to produce a sound from the operation knob.

### DESCRIPTION OF EMBODIMENTS

### Embodiment of the Invention

The switch device in the embodiment of the invention is a switch device 1 which is arranged in a steering wheel 8 of a vehicle 5 and has switch parts 30, 40 that are installed in the vehicle 5 and are provided with operation knobs 31, 41 and piezo elements 32, 42 acting as electromagnetic elements that detect an operation on the operation knobs 31, 41 and also cause vibration of the operation knobs 31, 41, and a control unit 100 that performs at least one of first control and second control, the first control being performed to control the piezo elements 32, 42 such that the operation knobs 31, 41 vibrate in response to the operation, and the second control being performed to control the piezo elements 32, 42 such that the operation knobs 31, 41 vibrate in the audible band, and the switch device 1 is positioned to achieve high directivity such that sounds emitted from the operation knobs 31, 41 are concentrated toward the ears of a driver 20 that is an occupant of the vehicle 5.

In the present embodiment, an example in which the occupant is the driver 20 will be described.

(Switch Parts 30 and 40)

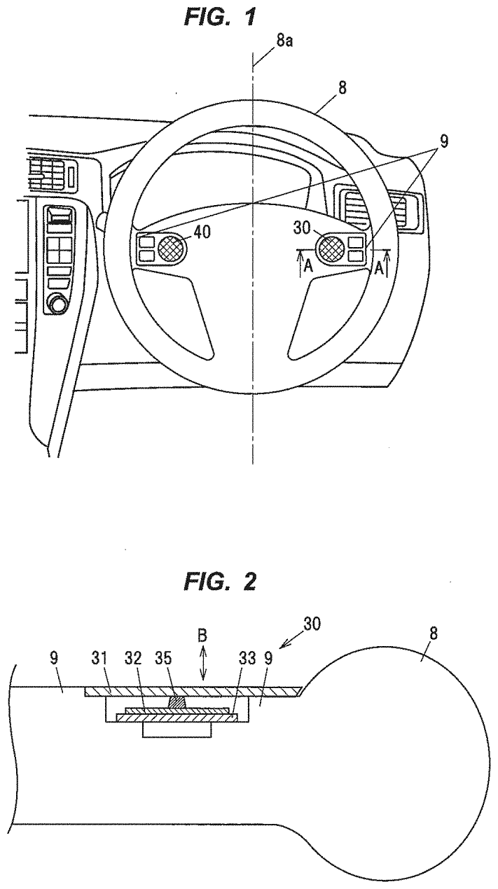

As shown in FIG. 1, the switch parts 30, 40 are attached to the steering wheel 8 of the vehicle 5. One or two or more switch parts are provided on the steering wheel 8. In the present embodiment, an example in which the two switch parts 30, 40 are symmetrically arranged across a center line 8a of the steering wheel 8 as shown in FIG. 1 will be described.

The switch parts 30, 40 are switches associated with vehicle operation and are steering switches which can be used for air-conditioning control, audio control, and car navigation operation, etc. The switch parts 30, 40 can be electrically connected to a vehicle main body via, e.g., a steering roll connector (not shown). A right sound signal S1 and a left sound signal S2, etc., to the switch parts 30, 40 can be input from the vehicle main body via, e.g., the steering roll connector.

As shown in FIG. 2, the switch part 30 is generally composed of the operation knob 31 which is a plate-shaped panel, and the piezo element 32 which is an electromagnetic element connected to the operation knob 31 via a transmission member 35. The transmission member 35 is a columnar body formed of a material capable of easily transmitting a force or vibration, e.g., a metal, a resin or an elastic body such as rubber. The piezo element 32 is mounted on a substrate 33 which is provided on a spoke 9. As shown in FIG. 2, the operation knob 31 is a plate-shaped panel and is arranged to be flush with the surface of the spoke 9, hence, a seamless switch with no level difference. The switch part 40 has the same configuration.

The piezo element 32 is, e.g., a unimorph piezoelectric element provided with a piezoelectric body having a disc shape and a metal shim having a disc shape with a larger radius than the piezoelectric body. An upper wiring is electrically connected to the piezoelectric body of the piezoelectric element and a lower wiring is electrically connected to the metal shim of the piezoelectric element.

As a modification, the piezoelectric element may be, e.g., a bimorph piezoelectric element in which two piezoelectric bodies are provided on both sides of the metal shim.

The material used to form the piezoelectric body is, e.g., lithium niobate, barium titanate, lead titanate, lead zirconate titanate (PZT), lead metaniobate or polyvinylidene fluoride (PVDF), etc. The piezoelectric body is, e.g., a stacked piezoelectric body formed by stacking films of these materials. The piezoelectric body is poled in a thickness direction and produces larger output when deformed in the thickness direction. The metal shim is formed of, e.g., conductive phosphor bronze or conductive stainless steel, etc.

When the operation knob 31 is pushed, the piezo element 32 generates voltage corresponding to the pushing force and produces a push operation signal S0. The piezo element 32 thereby acts as a switching element which detects an operation on the operation knob 31.

The piezo element 32 also deforms upon application of voltage and displaces the operation knob 31, which is connected thereto via the transmission member 35, in a vertical direction B shown in FIG. 2. The piezo element 32 thereby acts as an actuator which provides tactile sensation from the piezo element 32 side to the finger, etc., performing an operation on the operation knob 31 and also acts as a sound source which produces sound by vibration of the operation knob 31 in the audible band caused by the piezo element 32.

By having the configuration described above, the operation knob 31 acts as a touch portion for providing tactile sensation and also acts as a sound source (speaker) for producing sound by being vibrated in the audible band. Therefore, the switch parts 30, 40 can output sound in a predetermined frequency band and can output, e.g., warning tones or warning sound, etc., based on control from the vehicle side.

The electromagnetic element is not limited to the piezo element 32 described above. It is possible to use, e.g., a voice coil motor which is composed of a magnetic circuit and a coil and is configured to detect an operation force on the coil based on a current produced in the coil by the movement thereof and to generate vibration by movement of the coil caused by a change in the magnetic field on the magnetic circuit side.

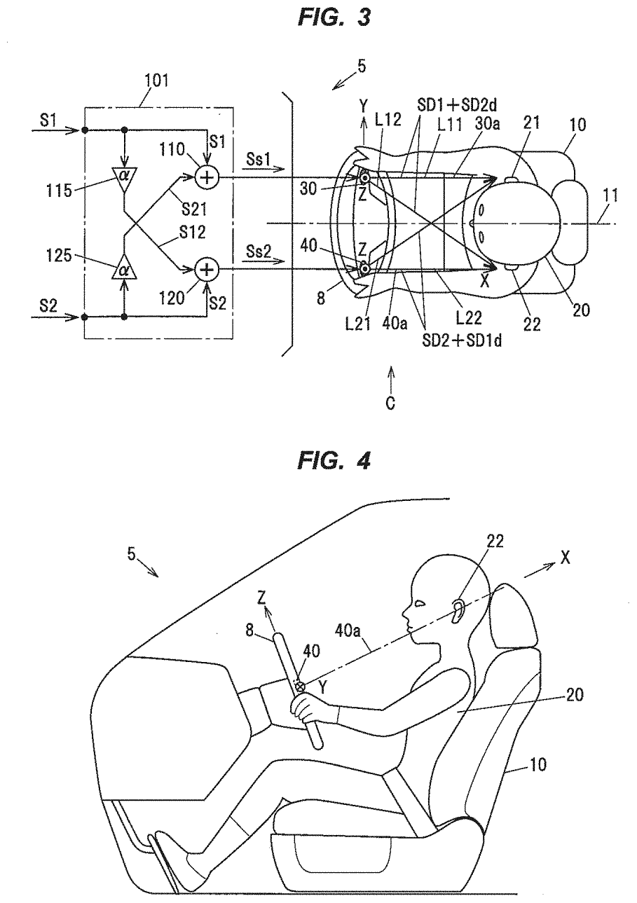

In FIG. 3, a direction from the switch part to the ears of the driver 20 and from the front toward the rear of the vehicle 5 is defined as the X direction, a width direction of the vehicle 5 is defined as the Y direction, and a vertical direction of the vehicle 5 as the cross product of the X axis and the Y axis is defined as the Z direction. As shown in FIG. 3, the switch part 30 is positioned to have high directivity in a direction toward the right ear 21 of the driver 20. Likewise, the switch part 40 is positioned to have high directivity in a direction toward the left ear 22 of the driver 20. That is, by mounting the switch parts 30, 40 on the steering wheel 8, an output axis 30a of the switch part 30 can be oriented in the direction toward the right ear 21 of the driver 20, and an output axis 40a of the switch part 40 can be oriented in the direction toward the left ear 22 of the driver 20.

Meanwhile, as shown in FIG. 4, the switch part 40 is arranged to face slightly upward and toward the ears of the driver 20. Thus, the X axis and the Z axis are slightly rotated about the Y axis, as shown in FIG. 4.

As shown in FIG. 4, since the switch parts 30, 40 are mounted on the steering wheel 8, the switch part 40 is arranged to face slightly upward (the X axis direction) so that the output axis 40a of the switch part 40 is oriented in the direction toward the left ear 22 of the driver 20. The switch part 30 is also arranged to face slightly upward (the X axis direction) in the same manner. In this arrangement, the two switch parts 30, 40 has high directivity in the direction toward the ears 21, 22 of the occupant. Thus, sounds emitted from the operation knobs 31, 41 are concentrated toward the ears 21, 22 of the driver 20 of the vehicle 5.

(Configuration of the Control Unit 100)

The control unit 100 is provided with, e.g., a microcomputer composed of a CPU (Central Processing Unit) performing predetermined calculation and processing, etc., according to a stored program, a RAM (Random Access Memory) and a ROM (Read Only Memory) as semiconductor memories, etc. The ROM stores, e.g., a program for operation of the control unit 100 and various parameters, etc. The control unit 100 is also provided with a sound image controller 101 to control sound image localization.

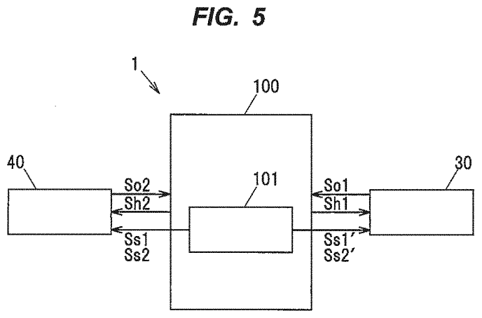

As shown in FIG. 5, the switch parts 30, 40 are connected to the control unit 100. Push operation signals S_{O1} and S_{O2} are input from the switch parts 30, 40. Then, in response to the push operation signals S_{O1} and S_{O2}, tactile sensation presentation signals Sh1, Sh2 to provide tactile sensation are output to the piezo elements 32, 42 of the switch parts 30, 40. In addition, sound signals Ss1, Ss2 to output warning tones or warning sound, etc., are also output to the piezo elements 32, 42 of the switch parts 30, 40 via the sound image controller 101.

(Tactile Sensation Presentation Control by the Control Unit 100)

As the first control, the control unit 100 controls the piezo elements 32, 42 so that the operation knobs 31, 41 vibrate in response to the operation. That is, based on the push operation signals S_{O1} and S_{O2}, tactile sensation can be provided by vibration, etc., to an operator operating the operation knobs 31, 41. When a push operation is performed, the control unit 100 outputs the tactile sensation presentation signals Sh1, Sh2 to the piezo elements 32, 42 to, e.g., thrust the operation knobs 31, 41 upward once or several times with a predetermined force, thereby providing tactile sensation. Alternatively, tactile sensation can be provided by vibrating at a predetermined cycle.

(Sound Image Localization Control by the Control Unit 100)

As the second control, the control unit 100 controls the piezo elements 32, 42 so that the operation knobs 31, 41 vibrate in the audible band. In addition, as a part of the second control, the control unit 100 controls properties of sound output from each of the switch parts 30, 40 so that a three-dimensional audio image produced by sounds output from the switch parts 30, 40 is maintained. This control is performed as follows.

As shown in FIG. 3, a drive part 110 for driving the switch part 30 (the piezo element 32) and a drive part 120 for driving the switch part 40 (the piezo element 42) are provided in the sound image controller 101. The drive part 110 drives the switch part 30 by amplifying the right sound drive signal Ss1 obtained by adding the right sound signal S1 to a phase shifted signal S21 of the left sound signal S2. Likewise, the drive part 120 drives the switch part 40 by amplifying the left sound drive signal Ss2 obtained by adding the left sound signal S2 to a phase shifted signal S12 of the right sound signal S1. Thus, the operation knob 31 of the switch part 30 vibrates, resulting in output of sound of the right channel based on the right sound drive signal Ss1, and also the operation knob 31 of the switch part 40 vibrates, resulting in output of sound of the left channel based on the left sound drive signal Ss2.

A phase shift circuit 115 shifts (delays) the phase of the right sound signal S1 and then outputs the phase shifted signal S12 to the drive part 120. For the phase shift, a phase difference α between the right sound signal S1 and the phase shifted signal S12 can be appropriately set.

Likewise, a phase shift circuit 125 shifts (delays) the phase of the left sound signal S2 and then outputs the phase shifted signal S21 to the drive part 110. For the phase shift, a phase difference α between the left sound signal S2 and the phase shifted signal S21 can be appropriately set. In this regard, the phase difference α here is used when the switch parts 30, 40 are symmetrically arranged across a center line 11 of a seat 10, and the phase difference can be different between the phase shift circuit 115 and the phase shift circuit 125 when, e.g., the switch parts 30, 40 are asymmetrically arranged across the center line 11 of the seat 10.

Gains of the drive parts 110, 120 and the phase shift circuits 115, 125 can be adjusted respectively. Thus, as shown in FIG. 3, it is possible to adjust an addition ratio of the right sound signal S1 to the phase shifted signal S21 in the drive part 110 and an addition ratio of the left sound signal S2 to the phase shifted signal S12 in the drive part 120. In addition, it is possible to adjust sound pressure output from the operation knob 31 of the switch part 30 and from the operation knob 41 of the switch part 40 and it is also possible to adjust the balance of stereo sound between left and right.

The control unit 100 controls properties of sound output from each switch part so that a three-dimensional audio image produced by sounds output from the two operation knobs 31, 41 is maintained.

Sound SD1 of the right channel and phase-shifted sound SD2d of the left channel, which are output from the switch part 30, and sound SD2 of the left channel and phase-shifted sound SD1d of the right channel, which are output from the switch part 40, reach the right ear 21.

The sound of the right channel reaching the right ear 21 is the sound SD1 of the right channel and the phase-shifted sound SD1d of the right channel.

The sound of the left channel reaching the right ear 21 is the sound SD2 of the left channel and the phase-shifted sound SD2d of the left channel.

Based on this, the control unit 100 performs control so that a synthetic sound of the sound SD1 of the right channel and the phase-shifted sound SD1d of the right channel is maximized and a synthetic sound of the sound SD2 of the left channel and the phase-shifted sound SD2d of the left channel is minimized.

In order that the synthetic sound of the sound SD1 of the right channel and the phase-shifted sound SD1d of the right channel is maximized at the right ear 21, for example, the control unit 100 sets the phase difference α so that the phase difference between the sound SD1 travelling a distance L11 and the sound SD1d travelling a distance L21 is 2πn (n=0, 1, 2 . . . ). Here, the distance L11 is a distance from the switch part 30 to the right ear 21, and the distance L21 is a distance from the switch part 40 to the right ear 21.

In order that the synthetic sound of the sound SD2 of the left channel and the phase-shifted sound SD2d of the left channel is minimized at the right ear 21, the phase difference α is set so that the phase difference between the sound SD2 travelling the distance L21 and the sound SD2d travelling the distance L11 is πn (n=0, 1, 2 . . . ).

At the position of the right ear 21, the sound SD1 of the right channel and the sound SD2 of the left channel cancel each other out or crosstalk therebetween is reduced by the above-described setting in which the synthetic sound of the sound SD2 of the left channel and the phase-shifted sound SD2d of the left channel is minimized at the right ear 21.

Likewise, the sound SD2 of the left channel and the phase-shifted sound SD1d of the right channel, which are output from the switch part 40, and the sound SD1 of the right channel and the phase-shifted sound SD2d of the left channel, which are output from the switch part 30, reach the left ear 22.

The sound of the left channel reaching the left ear 22 is the sound SD2 of the left channel and the phase-shifted sound SD2d of the left channel.

The sound of the right channel aching the left ear 22 is the sound SD1 of the right channel and the phase-shifted sound SD1d of the right channel.

Based on this, the control unit 100 performs control so that a synthetic sound of the sound SD2 of the left channel and the phase-shifted sound SD2d of the left channel is maximized and a synthetic sound of the sound SD1 of the right channel and the phase-shifted sound SD1d of the right channel is minimized.

In order that the synthetic sound of the sound SD2 of the left channel and the phase-shifted sound SD2d of the left channel is maximized at the left ear 22, for example, the control unit 100 sets the phase difference α so that the phase difference between the sound SD2 travelling a distance L22 and the sound SD2d travelling a distance L12 is 2πn (n=0, 1, 2 . . . ). Here, the distance L22 is a distance from the switch part 40 to the left ear 22, and the distance L12 is a distance from the switch part 30 to the left ear 22.

In order that the synthetic sound of the sound SD1 of the right channel and the phase-shifted sound SD1d of the right channel is minimized at the left ear 22, the phase difference a is set so that the phase difference between the sound SD1 travelling the distance L12 and the sound SD1d travelling the distance L22 is πn (n=0, 1, 2 . . . ).

At the position of the left ear 22, the sound SD2 of the left channel and the sound SD1 of the right channel cancel each other out or crosstalk therebetween is reduced by the above-described setting in which the synthetic sound of the sound SD1 of the right channel and the phase-shifted sound SD1d of the right channel is minimized at the left ear 22.

Due to the phase shift controlled by the control unit 100, it is possible to allow sound to be localized at the ears and it is also possible to perform control so that a three-dimensional audio image produced by sounds output from the two switch parts 30, 40 is maintained.

(Operation Example of the Switch Parts 30 and 40)

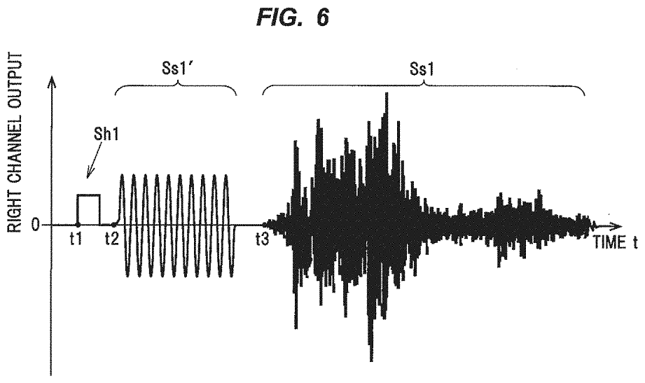

The operation of the switch parts 30, 40 will be described using a waveform example of the drive signal of the right channel shown in FIG. 6 which is a signal for driving the operation knob. The control unit 100 outputs, e.g., the drive signal Sh1 for tactile sensation presentation to the piezo element 32 at time t1 in response to the push operation on the operation knob and thereby makes the operation knob 31 vibrate. Tactile sensation is presented by, e.g., motion of thrusting the operation knob 31 upward by a single pulse, as shown in FIG. 6.

Then, at time t2, a sine wave with a frequency in the audible band is generated as the drive signal Ss1′ and is output to the piezo element 32, thereby vibrating the operation knob 31. This produces a beep as a warning tone which provides a warning announcement to the driver 20. The switch part 30 acts as a sound source (speaker) for producing warning sound.

Then, at time t3, a sound signal in the audible band is generated as the drive signal Ss1 and is output to the piezo element 32 via the sound image controller 101. A sound signal in the audible band, which corresponds to the drive signal Ss1 in a stereo manner, is also generated as the drive signal Ss2 of the left channel and is output to the piezo element 42 via the sound image controller 101. Thus, the operation knobs 31, 41 can vibrate in response to the sound signals. The switch parts 30, 40 can act as sound sources (speakers) for generating warning sound and allow for sound localization control so that a three-dimensional audio image is maintained.

The present embodiment is not limited to the use of two switch parts and is also applicable to when not less than three switch parts are arranged across the center line 8a of the steering wheel. That is, taking into consideration the distance from the switch part to the ear of the occupant and the phase difference for the sound output from each switch port, the phase difference is set so that the synthetic sounds are maximized/minimized at the right ear and the left ear respectively, and this cancels out sounds of the right and left channel and reduces crosstalk therebetween. Thus, even in case that three or more switch parts are provided, it is possible to allow sound to be localized at the ears and it is also possible to perform control so that a three-dimensional audio image produced by sounds output from the three or more switch parts is maintained.

### Effects of the Embodiment

The following effects are obtained in the embodiment of the invention.

(1) The switch device in the embodiment of the invention is the switch device 1 which is arranged in the steering wheel 8 of the vehicle 5 and has the switch parts 30, 40 that are installed in the vehicle 5 and are provided with the operation knobs 31, 41 and the piezo elements 32, 42 acting as electromagnetic elements that detect an operation on the operation knobs 31, 41 and also cause vibration of the operation knobs 31, 41, and the control unit 100 that performs at least one of first control and second control, the first control being performed to control the piezo elements 32, 42 such that the operation knobs 31, 41 vibrate in response to the operation, and the second control being performed to control the piezo elements 32, 42 such that the operation knobs 31, 41 vibrate in the audible band, and the switch device 1 is positioned to achieve high directivity such that sounds emitted from the operation knobs 31, 41 are concentrated toward the ears of the driver 20 that is an occupant of the vehicle 5. As a result, the switch parts act to provide tactile sensation in response to the push operation on the operation knobs under the first control, and also act as sound sources (speakers) for generating sound by being vibrated in the audible band under the second control.

(2) The switch part can be mounted on the steering wheel, etc., of the vehicle main body. Therefore, it is not necessary to provide a space for mounting a speaker for producing sound and this contributes to size reduction.

(3) Since the electromagnetic element (the piezo element) provided on the switch part to provide tactile sensation can be also used to produce tone or sound, the switch device 1 can have a speaker function without increasing the cost.

Although some embodiments of the invention have been described above, the embodiments are merely exemplary and the invention according to claims is not to be limited thereto. These new embodiments may be implemented in various other forms, and various omissions, substitutions and changes, etc., can be made without departing from the gist of the invention. In addition, all combinations of the features described in these embodiments are not necessary to solve the problem of the invention. Further, these embodiments are included within the scope and gist of the invention and also within the invention described in the claims and the equivalency thereof.

### REFERENCE SIGNS LIST

1 SWITCH DEVICE

5 VEHICLE

8 STEERING WHEEL

8a CENTER LINE

10 SEAT

11 CENTER LINE

20 DRIVER

21 RIGHT EAR

22 LEFT EAR

30 SWITCH PART

31 OPERATION KNOB

32 PIEZO ELEMENT

40 SWITCH PART

41 OPERATION KNOB

42 PIEZO ELEMENT

100 CONTROL UNIT

110 DRIVE PART

115 PHASE SHIFT CIRCUIT

120 DRIVE PART

125 PHASE SHIFT CIRCUIT

1. A switch device that is installed on a steering wheel of a vehicle, the switch device comprising:
a switch part that is installed on the vehicle and comprises an operation knob and an electromagnetic element for detecting an operation on the operation knob and causing a vibration of the operation knob; and
a control unit that performs at least one of a first control and a second control, the first control controlling the electromagnetic element such that the operation knob vibrates in response to the operation, and the second control controlling the electromagnetic element such that the operation knob vibrates at an audible band,
wherein the switch device is positioned such that a directivity of a sound emitted from the operation knob is increased toward an ear of an occupant of the vehicle.

2. The switch device according to claim 1, wherein as the second control, the control unit drives the electromagnetic element so that a warning tone or warning sound is output from the operation knob.

3. The switch device according to claim 2, wherein the control unit outputs a sine-wave drive signal with a frequency in the audible band to the electromagnetic element so that the warning tone is output from the operation knob.

4. The switch device according to claim 2, wherein the control unit outputs a drive signal based on a sound signal in the audible band, to the electromagnetic element so that the warning sound is output from the operation knob.

5. The switch device according to claim 1, wherein the electromagnetic element comprises a piezoelectric element.

6. The switch device according to claim 1, wherein the number of the switch parts provided on the steering wheel is at least two, and
wherein the control unit performs, as a part of the second control, control of properties of sound output from each switch part so that a three-dimensional audio image produced by sounds output from the switch parts is maintained.

7. The switch device according to claim 6, wherein the at least two switch parts are arranged across a center line passing through the center of a seat or the steering wheel in the vehicle.

8. The switch device according to claim 6, wherein one of the at least two switch parts which is located on a right side with respect to the center line is positioned to increase the directivity toward a right ear of the occupant, and
wherein one of the at least two switch parts which is located on a left side with respect to the center line is positioned to increase the directivity toward a left ear of the occupant.

9. The switch device according to claim 6, wherein the control unit comprises a phase shift means and an adding means,
wherein the phase shift means performs a phase-delay process to the sound signal of a right channel corresponding to the one of the at least two switch parts located on the right side with respect to the center line and to the sound signal of a left channel corresponding to the one of the at least two switch parts located on the left side with respect to the center line, and
wherein the adding means outputs a drive signal of the right and left channels respectively by adding the sound signal of the right channel to the sound signal of the left channel phase-delayed by the phase shift means and the sound signal of the left channel to the sound signal of the right channel phase-delayed by the phase shift means.

10. The switch device according to claim 9, wherein the control unit sets respective phase differences in the phase shift means so that, at the right ear of the occupant, a synthetic sound of sound based on the sound signal of the right channel and sound based on the sound signal of the right channel phase-delayed by the phase shift means is maximized and a synthetic sound of sound based on the sound signal of the left channel and sound based on the sound signal of the left channel phase-delayed by the phase shift means is minimized, and at the left ear of the occupant, a synthetic sound of sound based on the sound signal of the left channel and sound based on the sound signal of the left channel phase-delayed by the phase shift means is maximized and a synthetic sound of sound based on the sound signal of the right channel and sound based on the sound signal of the right channel phase-delayed by the phase shift means is minimized.
